(19) United States
(12) Patent Application Publication
(10) Pub. No.: US 2024/0295249 A1
(43) Pub. Date: Sep. 5, 2024

(54) STRUCTURAL DAMPER FOR PROTECTING STRUCTURES AGAINST VIBRATIONS AND STRUCTURE COMPRISING SUCH A STRUCTURAL DAMPER

(71) Applicant: Maurer Engineering GmbH, München (DE)

(72) Inventor: Felix WEBER, Pfaffhausen (CH)

(21) Appl. No.: 18/268,870

(22) PCT Filed: Aug. 31, 2021
(86) PCT No.: PCT/EP2021/073942

§ 371 Date: Jun. 21, 2023

(30) Foreign Application Priority Data
Dec. 23, 2020 (DE) 10 2020 216 569.6

(51) Int. Cl. F16F 7/10; E04B 1/98; F03D 13/20; F16F 7/104

(52) U.S. Cl. CPC F16F 7/1017; E04B 1/98; F03D 13/20; F16F 7/104; F05B 2260/964; F16F 2230/0023; F16F 2232/06; F16F 2238/04

(57) ABSTRACT

The present invention relates to a structural damper 1 for protecting structures against vibrations, comprising a first pendulum 3 having a first pendulum mass 3a, a second pendulum 4 having a second pendulum mass 4a, a coupling device 5 and a damping device 6. The coupling device 5 is disposed between the first pendulum mass 3a and the second pendulum mass 4a, and is configured to couple the first pendulum mass 3a to the second pendulum mass 4a in an effective direction of the structural damper 1 and to allow relative movement between the first pendulum mass 3a and the second pendulum mass 4a in a direction of movement angled with respect to the effective direction. The damping device 6 is disposed between the first pendulum mass 3a and the second pendulum mass 4a, and is configured to damp relative movement in the direction of movement between the first pendulum mass 3a and the second pendulum mass 4a.

The present invention relates to a structural damper for protecting structures against vibrations. Furthermore, the present invention relates to a structure having such a structural damper.

Slender structures such as high-rise buildings (residential use, office use, hotel use) or other slender structures (wind turbines, observation towers, etc.) are excited to horizontal vibrations by wind excitation. The usual countermeasure is the installation of a vibration damper in the form of the Tuned Mass Damper (TMD), which reduces the structural vibrations (displacement and accelerations) via its pendulum mass coupled to the structure by means of damping elements and stiffness elements.

Such structural dampers are already known in various forms from the state of the art. For example, there are solutions in which the mass of the TMD is suspended as a transversal pendulum on cables or pendulum rods. There are also variants in which the mass of the TMD is suspended as a physical pendulum using a pendulum rod with a cardan joint. The aforementioned TMD types can be designed to reduce horizontal structural vibration in one horizontal direction, in two mutually orthogonal directions, or in any direction of the plane. In either case, the damping elements as well as the spring elements (cables, pendulum rods or springs) are installed horizontally between the TMD mass and the structure, whereby the damping elements act in proportion to the relative velocity of the TMD mass to the structure mass and the spring elements act in proportion to the relative displacement of the TMD mass to the structure mass. The aim of these solutions is that the horizontal force of the damping elements tunes the damping of the TMD mass in the horizontal direction and the horizontal force of the spring elements tunes the natural frequency of the TMD mass in the horizontal direction.

In order to reduce the installation height of TMDs in pendulum design for very low-frequency structural vibrations, the following concepts are also available. For example, the mass of the TMD can be supported horizontally on rollers or on a sliding plane. In another embodiment, a nested pendulum is provided in which a second frame is suspended from the outer cables with a pendulum mass attached to it. Another variant considers a pendulum mass suspension by means of cables inclined outwardly at an angle. In addition, there are solutions in which the entire pendulum mass is divided between a suspended pendulum mass and a pendulum mass supported on pendulum supports, with both masses coupled by a coupling rod. The pendulum mass supported on the pendulum supports acts as an inverted pendulum, producing a negative stiffness force. This negative stiffness force together with the positive stiffness force of the suspended pendulum mass results in an overall small stiffness force, which means that the natural frequency of the entire TMD can be very low. This TMD type is called “Compound TMD”. Further, in all known TMD types, which reduce the installation height, the damping elements and the spring elements are always arranged between the pendulum mass and the structure, so that the damping elements work proportionally to the relative velocity of the TMD mass to the structure mass and the spring elements work proportionally to the relative displacement of the TMD mass to the structure mass.

The structural dampers described above are associated with increased expense and still require a large installation space within the structures to be protected. It is therefore the task of the present invention to provide an improved structural damper for protecting structures against vibrations, which requires a small installation space or is as compact and simple in design as possible and at the same time operates reliably. Furthermore, it is the task of the present invention to provide a structure with such a structural damper.

According to the invention, the solution of the aforementioned problem is achieved with a structural damper according to claim 1 and a structure according to claim 26. Advantageous further embodiments of the invention result from dependent claims 2 to 25.

The structural damper according to the invention for protecting structures against vibrations thus comprises a first pendulum with a first pendulum mass, a second pendulum with a second pendulum mass, a coupling device and a damping device. The coupling device is disposed between the first pendulum mass and the second pendulum mass and is configured to couple the first pendulum mass to the second pendulum mass in an effective direction of the structural damper, and to permit relative movement between the first pendulum mass and the second pendulum mass in a direction of movement angled with respect to the effective direction. The structural damper is characterized in that the damping device is disposed between the first pendulum mass and the second pendulum mass and is configured to damp relative motion in the direction of motion between the first pendulum mass and the second pendulum mass.

The coupling in the effective direction of the structural damper from the first pendulum mass to the second pendulum mass has the effect of preventing relative movement in the effective direction between the first pendulum mass and the second pendulum mass. The relative motion in the direction of motion between the first pendulum mass and the second pendulum mass is not limited to pure motion in that direction. The relative motion in the direction of motion also includes motions that include a component in the direction of motion. In other words, a height offset in the direction of motion between the first pendulum mass and the second pendulum mass that changes with the motion is determinative. This includes movements in which the first pendulum mass is tilted relative to the second pendulum mass, so that only portions of the first pendulum mass perform a relative movement in the direction of movement relative to portions of the second pendulum mass. Advantageously, the direction of movement is perpendicular to the effective direction.

Due to the arrangement and design of the coupling device and damping device between the two pendulum masses, they operate proportionally to the relative displacement or relative velocity in the direction of movement between the two pendulum masses and not, as in conventional TMDs, proportionally to the horizontal relative displacement or relative velocity between the total pendulum mass and the structure mass. When the two pendulum masses are displaced, the damping device acts on both pendulum masses via its force component in the effective direction, thus producing damping of the coupled pendulum masses in the effective direction. This new TMD type is called “Compact TMD”. A complex and space-intensive mounting of a damper element between the pendulum mass or pendulum masses and the building mass is no longer necessary.

Preferably, the effective direction of the structural damper has a horizontal component or is in a horizontal direction. This means that the structural damper is designed to protect the structure against horizontally occurring vibrations or vibrations with a horizontal component. When the two pendulum masses are displaced horizontally, the damper acts on both pendulum masses via its horizontal force component in the horizontal direction and thus generates damping of the coupled pendulum masses in the horizontal direction.

Preferably, the direction of movement has a vertical component or is in a vertical direction. As a result, the structural damper is optimally matched to the typical movements of a pendulum.

Advantageously, the first pendulum is a hanging pendulum, preferably having a rope suspension or pendulum rod suspension. The hanging pendulum may be of any type. For example, the hanging pendulum may have only a single pendulum rod or a single pendulum cable. It would also be possible to use two or more pendulum rods and/or pendulum cables. With a hanging pendulum, the first pendulum represents a particularly stable pendulum, since gravity returns the pendulum mass to its central rest position after displacement from the central rest position.

In a further embodiment, the second pendulum is an inverted pendulum, in particular a standing pendulum. Again, any embodiment of the inverted pendulum is conceivable. For example, the inverted pendulum has one, two or more pendulum supports. Compared to the first hanging pendulum, the inverted pendulum represents an unstable pendulum. By dividing the pendulum mass into a hanging pendulum mass and a standing pendulum mass, the overall height of the structural damper can be significantly reduced while achieving very low natural frequencies.

Preferably, the first pendulum mass is arranged below or above the second pendulum mass in the vertical direction or in the direction of movement. As a result, the installation space in the horizontal direction or in a direction perpendicular to the direction of movement can be significantly reduced. Depending on whether the first pendulum mass is arranged below or above the second pendulum mass, the first pendulum and/or the second pendulum can be provided with the longest possible pendulum length despite a reduced installation height in the vertical direction or in the direction of movement. As a result, the damping behavior and the natural frequency of the entire pendulum can be optimally adjusted to the existing requirements despite the reduced installation height.

In a further embodiment, the coupling device is arranged in the direction of movement between the first pendulum mass and the second pendulum mass. In principle, the coupling device does not have to be aligned in the direction of movement for this purpose. The arrangement in the direction of movement between the first pendulum mass and the second pendulum mass thus also includes constellations in which the coupling device is arranged at an oblique angle to the direction of movement. With this feature, the structural damper can be provided in a particularly compact manner or with the smallest possible installation space.

Preferably, the coupling device is integrated into the first pendulum mass and/or the second pendulum mass. For example, a partial area of the first pendulum mass and/or the second pendulum mass can be formed in such a way that it represents a part of the coupling device. Thus, an extension or recess in the respective pendulum mass would be conceivable. It would also be possible for a part of the coupling device to be arranged in a recess of the first pendulum mass and/or the second pendulum mass. With this feature, the structural damper can be provided in a particularly compact manner or with the smallest possible installation space.

In a further embodiment, the coupling device comprises a guide element, preferably acting in and/or being arranged in the direction of movement. The guide element can be of any type. For example, the guide element may be a rectilinear guide rail or rectilinear guide tube. Preferably, the guide element is made of metal, for example steel or aluminum. It would also be conceivable to design it as a recess or guide channel that runs inside the first pendulum mass and/or the second pendulum mass. In one example, the coupling device further comprises a coupling element that is operatively connected to the guide element. Preferably, the coupling element is a rod, tube, some type of guide or corresponding extension of the first pendulum mass and/or the second pendulum mass that engages the guide element. In one example, the first pendulum mass has the guide element and the second pendulum mass has the coupling element, or vice versa. In another example, the first pendulum mass and the second pendulum mass each have a guide element and the coupling element engages both guide elements. By means of the guide element and the coupling element, the coupling of the first pendulum mass with the second pendulum mass in the effective direction can be established in a particularly simple manner. In addition, the relative movement in the direction of movement between the first pendulum mass and the second pendulum mass is simultaneously permitted in a particularly simple manner.

Advantageously, the coupling device has an end stop designed to limit the relative movement in the direction of movement between the first pendulum mass and the second pendulum mass. The end stop may be configured, for example, as a simple stop plate or as a complex stop mechanism. Preferably, the end stop is integrated into the guide element. In one example, the end stop limits the movement of the first pendulum mass and the second pendulum mass apart in the direction of movement when the entire pendulum is displaced. Preferably, the end stop has a damping material, such as plastic. However, a more stable material can also be provided here, such as metal. The end stop limits the maximum distance in the direction of movement between the two pendulum masses and thus the maximum pendulum movement of the entire pendulum mass. In this way, the structural damper or the entire pendulum can be kept within a stable working range.

In a further embodiment, the coupling device comprises an active stop device configured to limit and, to change, preferably during a state of use of the structural damper, a maximum possible relative movement in the direction of movement between the first pendulum mass and the second pendulum mass. This allows the active stop device to further reduce and ultimately stop the displacement in the direction of movement between the two pendulum masses from oscillation cycle to oscillation cycle, thereby allowing the two pendulum masses to be held in a centered position to perform inspection, maintenance, repair, and other operations. For example, the active stop device may include a stop plate and a movement mechanism by which the stop plate may be changed in position. Preferably, the active stop device is integrated into the guide element. In this case, the position of the stop plate can be changed within or along the guide element.

Advantageously, the damping device is arranged in the direction of movement between the first pendulum mass and the second pendulum mass. In principle, the damping device does not have to be aligned in the direction of movement for this purpose. The arrangement in the direction of movement between the first pendulum mass and the second pendulum mass thus also includes constellations in which the damping device is arranged at an oblique angle to the direction of movement. With this feature, the structural damper can be provided in a particularly compact manner or with the smallest possible installation space. The damping device can be designed separately from the coupling device. However, it would also be conceivable for the damping device to be integrated into the coupling device.

In an advanced embodiment, the damping device is arranged laterally on the first pendulum mass and/or the second pendulum mass in the direction of movement. Preferably, the first pendulum mass and/or the second pendulum mass each has a lateral extension between which the damping device is arranged. The arrangement in the direction of movement between the first pendulum mass and the second pendulum mass also includes constellations in which the damping device is arranged at an oblique angle to the direction of movement. With this feature, the structural damper can be provided in a particularly compact manner or with the smallest possible installation space.

Preferably, the damping device is integrated into the first pendulum mass and/or the second pendulum mass. For example, a partial area of the first pendulum mass and/or the second pendulum mass can be formed in such a way that it constitutes a part of the damping device. It would also be conceivable that a portion of the damping device is arranged in a recess of the first pendulum mass and/or the second pendulum mass. With this feature, the structural damper can be provided in a particularly compact manner or with the smallest possible installation space.

In a further embodiment, the damping device has linear-viscous, non-linear-viscous or active damping properties. This allows the structural damper or damping device to be optimally adjusted to the requirements at hand.

Preferably, the damping device has a passive hydraulic damper, a semi-active hydraulic damper, an eddy current damper and/or an active element, in particular an electric motor or a hydraulic actuator. As a result, the structural damper or the damping device can be optimally adjusted to the requirements at hand.

Advantageously, the structural damper includes a stiffness device disposed between the first pendulum mass and the second pendulum mass to stiffen the relative motion in the direction of motion between the first pendulum mass and the second pendulum mass. The stiffness device acting in the direction of motion allows fine tuning of the natural frequency of the coupled pendulum masses, since the displacement of the pendulum causes the force of the stiffness device acting in the direction of motion to exert a component in the direction of action on the pendulum masses.

In an advantageous embodiment, the stiffness device is arranged in the direction of motion between the first pendulum mass and the second pendulum mass. In principle, the stiffness device does not need to be aligned in the direction of motion for this purpose. The arrangement in the direction of movement between the first pendulum mass and the second pendulum mass thus also includes constellations in which the stiffness device is arranged at an oblique angle to the direction of movement. With this feature, the structural damper can be provided in a particularly compact manner or with the smallest possible installation space. The stiffness device can be designed separately from the coupling device. However, it would also be conceivable for the stiffness device to be integrated into the coupling device.

Preferably, the stiffness device is arranged laterally on the first pendulum mass and/or the second pendulum mass in the direction of movement. Preferably, the first pendulum mass and/or the second pendulum mass each has a lateral extension between which the stiffness device is arranged. The arrangement in the direction of movement between the first pendulum mass and the second pendulum mass also includes constellations in which the stiffness device is arranged at an oblique angle to the direction of movement. With this feature, the structural damper can be provided in a particularly compact manner or with the smallest possible installation space.

In a further development, the stiffness device is integrated into the first pendulum mass and/or the second pendulum mass. For example, a partial area of the first pendulum mass and/or the second pendulum mass can be formed in such a way that it constitutes a part of the stiffness device. It would also be conceivable that a portion of the stiffness device is arranged in a recess of the first pendulum mass and/or the second pendulum mass. With this feature, the structural damper can be provided in a particularly compact manner or with the smallest possible installation space.

Preferably, the stiffness device has a passive spring, a semi-active hydraulic damper and/or an active element, in particular an electric motor or a hydraulic actuator. This allows the structural damper or the stiffness device to be optimally adjusted to the requirements at hand.

Advantageously, the first pendulum is designed as a transversal pendulum or physical pendulum. In the present disclosure, a transversal pendulum is understood to be a pendulum in which the pendulum mass moves only translationally but not rotationally. In a physical pendulum, on the other hand, this coupling is rigidly designed, whereby in a physical pendulum the mass also moves rotationally. This means that the structural damper can be optimally adjusted to the requirements at hand.

Preferably, the second pendulum is designed as a transversal pendulum or physical pendulum. In the present disclosure, a transversal pendulum is understood to be a pendulum in which the pendulum mass moves only translationally but not rotationally. In a physical pendulum, on the other hand, this coupling is rigidly designed, whereby in a physical pendulum the mass also moves rotationally. This means that the structural damper can be optimally adjusted to the requirements at hand.

In an advanced embodiment, the second pendulum has a, preferably single, pendulum rod. In the case of a single pendulum rod, this may in particular be arranged centrally on the second pendulum mass. By a central arrangement it is understood in the present disclosure that the pendulum rod engages the second pendulum mass in a vertical direction below the center of gravity. This embodiment is particularly advantageous if the second pendulum is designed as a physical pendulum.

Preferably, the first pendulum mass and the second pendulum mass are coupled to each other in an articulated manner. For this purpose, the coupling device, in particular the guide element or the coupling element, preferably has a joint which allows the first pendulum mass to tilt with respect to the second pendulum mass. Particularly preferably, the damping device as well as the stiffness device also each have at least one joint so as not to block such tilting. This embodiment is particularly advantageous when the first pendulum is a transverse pendulum and the second pendulum is a physical pendulum. In this case, a displacement of the entire pendulum is still possible.

According to another aspect of the present invention, there is provided a structure having a structural damper described above, wherein the structure is preferably a wind turbine, a high-rise building or other slender structure. Thus, these are structures in which the installation space of the structural damper is limited. The structural damper has a reduced installation space within the structure, especially in the effective direction, and is comparatively simple in design. The structural damper also only has to be attached to the structure at its two pendulum ends. It is no longer necessary to attach a damper between the pendulum masses and the structure mass. The structural damper is therefore ideal for narrow structures with specific requirements, such as wind turbines and high-rise buildings.

In the following, advantageous embodiments of the present invention will now be described schematically with reference to figures, wherein

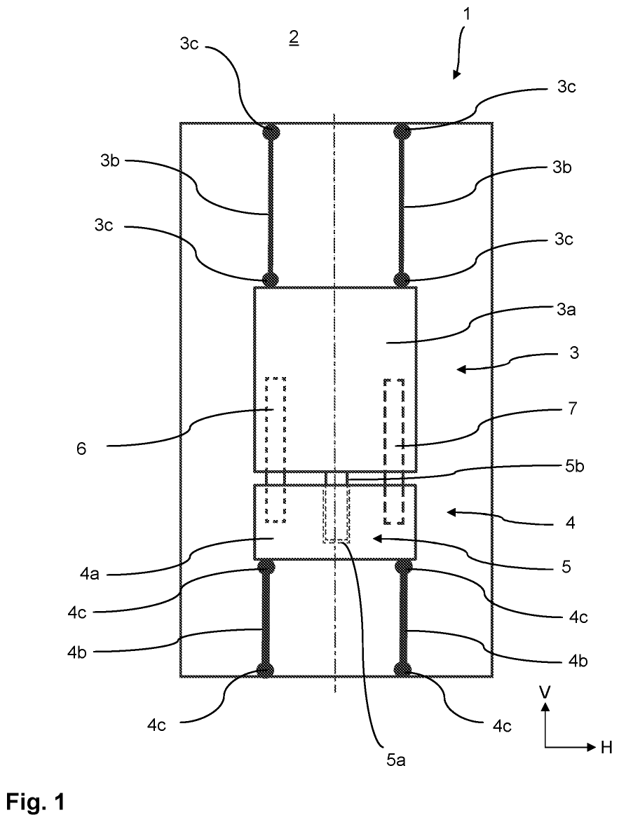

FIG. 1 is a side view of a structural damper according to a first embodiment of the present invention, wherein the first pendulum mass and the second pendulum mass are in a central position;

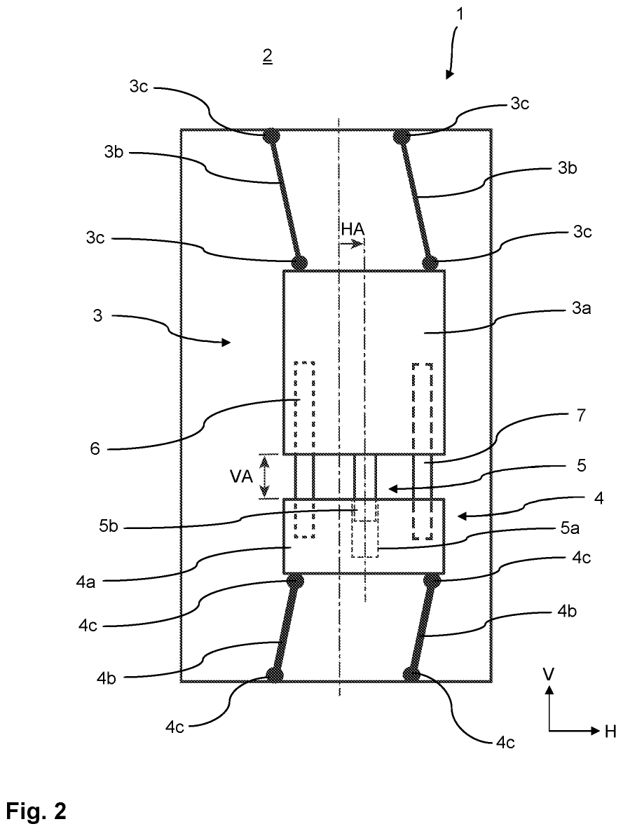

FIG. 2 is a side view of the structural damper shown in FIG. 1, in which the first pendulum mass and the second pendulum mass are in the displaced position;

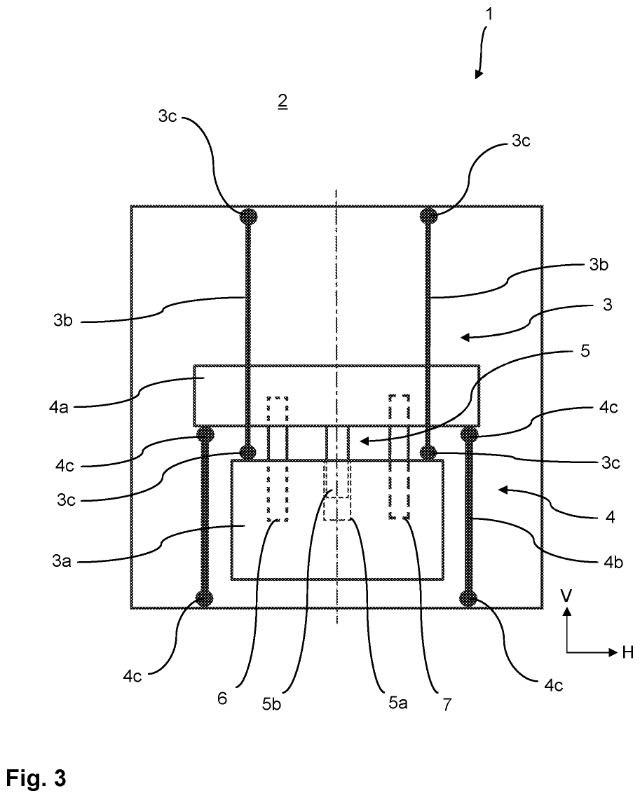

FIG. 3 is a side view of a structural damper according to a second embodiment of the present invention, in which the first pendulum mass and the second pendulum mass are in a central position;

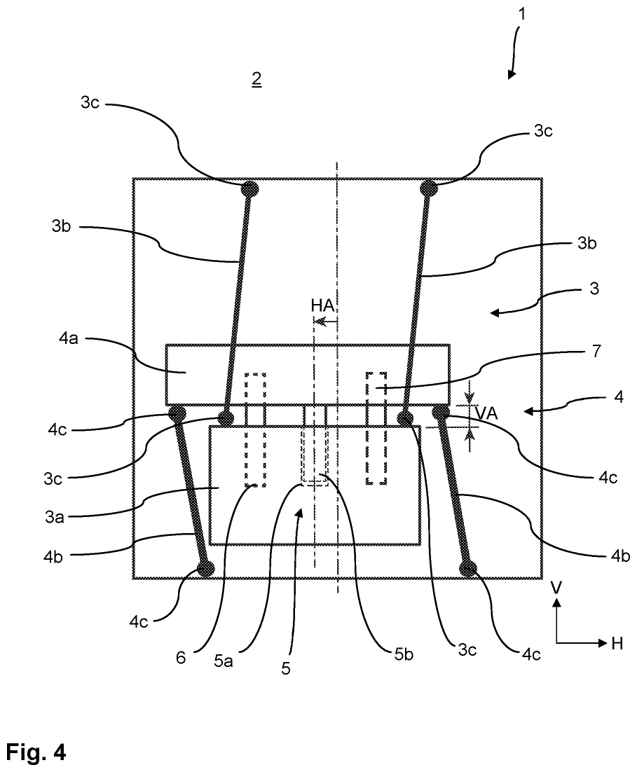

FIG. 4 is a side view of the structural damper shown in FIG. 3, in which the first pendulum mass and the second pendulum mass are in the displaced position;

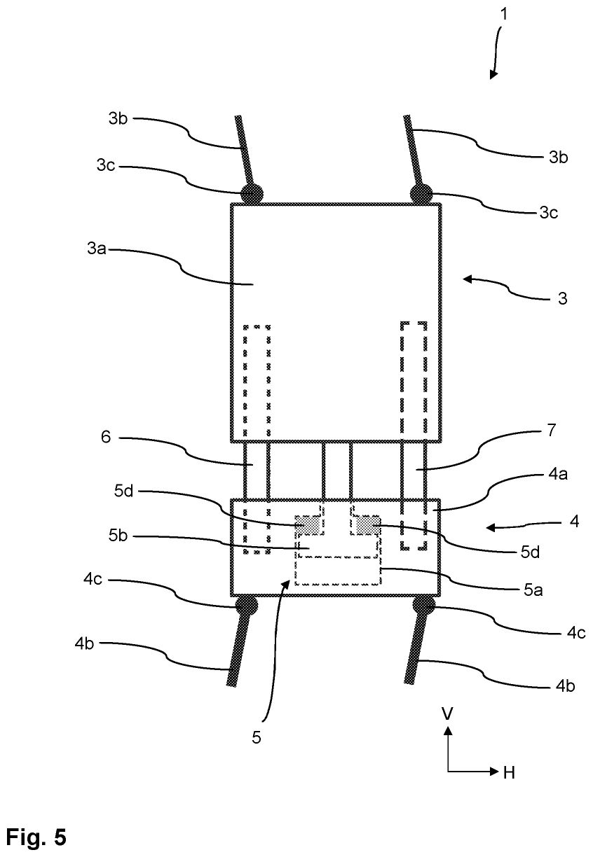

FIG. 5 is a section of a side view of a structural damper according to a third embodiment of the present invention, in which the first pendulum mass and the second pendulum mass are in a displaced position;

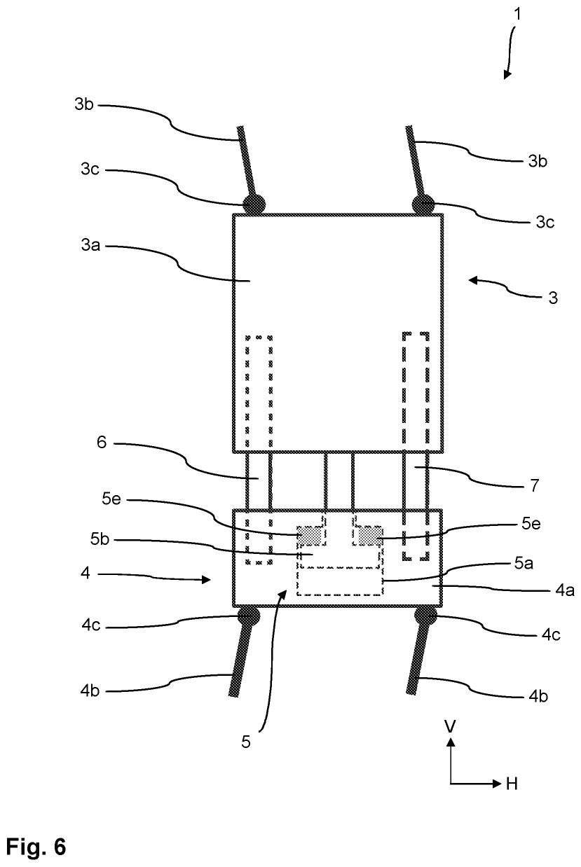

FIG. 6 is a section of a side view of a structural damper according to a fourth embodiment of the present invention, wherein the first pendulum mass and the second pendulum mass are in a displaced position;

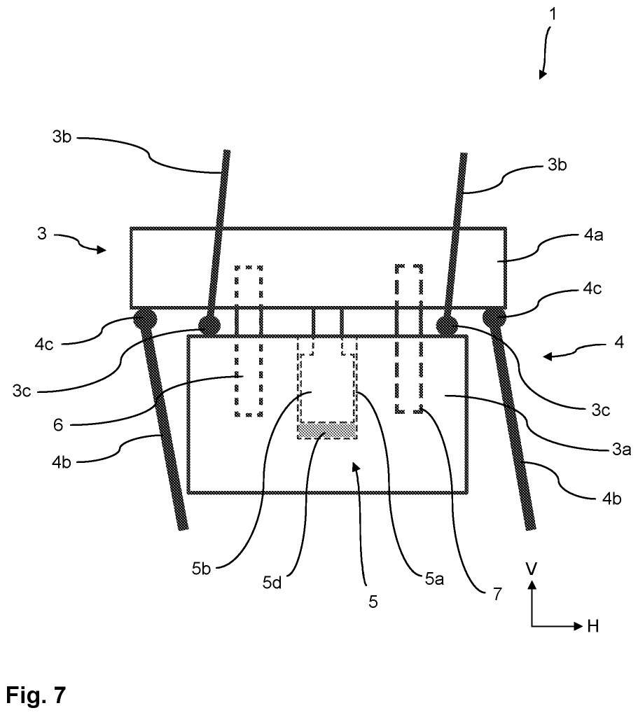

FIG. 7 is a section of a side view of a structural damper according to a fifth embodiment of the present invention, wherein the first pendulum mass and the second pendulum mass are in a displaced position;

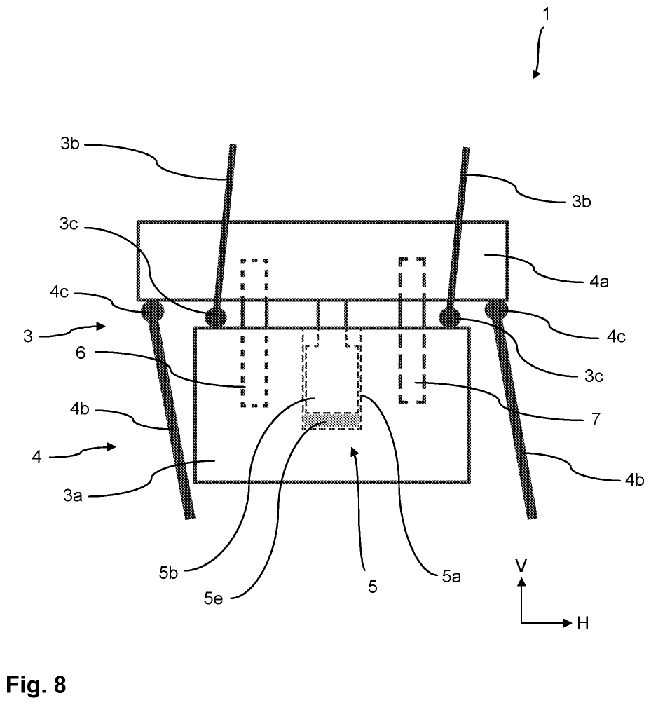

FIG. 8 is a section of a side view of a structural damper according to a sixth embodiment of the present invention, wherein the first pendulum mass and the second pendulum mass are in a displaced position;

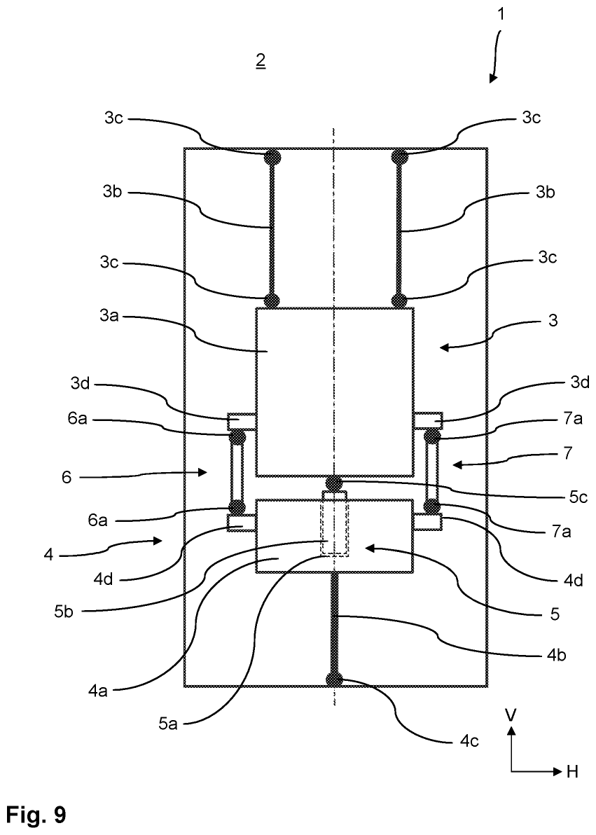

FIG. 9 is a side view of a structural damper according to a seventh embodiment of the present invention, in which the first pendulum mass and the second pendulum mass are in a central position;

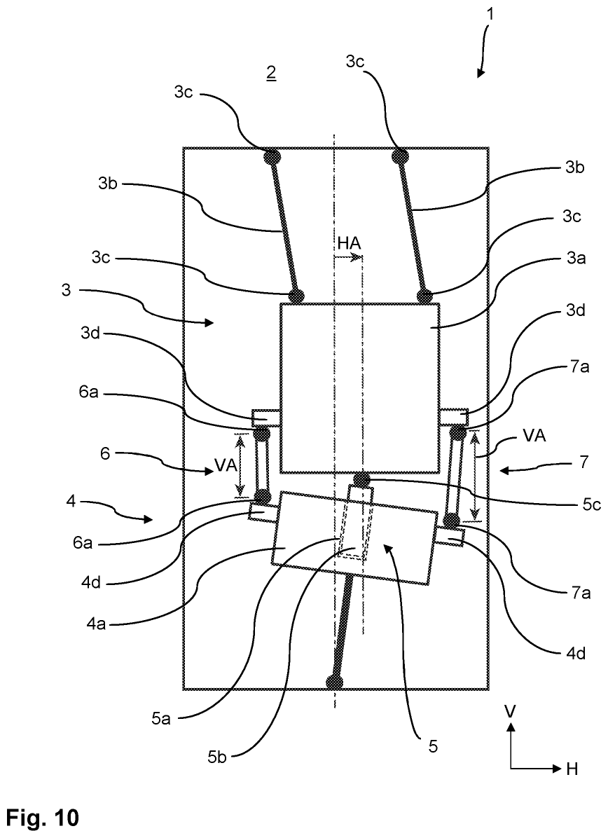

FIG. 10 is a side view of the structural damper shown in FIG. 9, in which the first pendulum mass and the second pendulum mass are in the displaced position;

Identical components in the various embodiments are identified by the same reference signs.

FIGS. 1 and 2 each show a structural damper 1 for protecting structures against vibrations according to a first embodiment of the present invention. The structural damper 1 is arranged within a structure 2 and includes a first pendulum 3 with a first pendulum mass 3a and a second pendulum 4 with a second pendulum mass 4a. The structure 2 is preferably a wind turbine or a high-rise building.

The first pendulum 3 is designed as a hanging pendulum that has a pendulum rod suspension. Alternatively, however, a rope suspension could also be used. In the present embodiment, the first pendulum 3 includes two pendulum rods 3b that engage above the two lateral ends of the first pendulum mass 3a. The first pendulum 3 is designed as a transverse pendulum. For this purpose, the first pendulum 3 has a joint 3c in the form of a cardan joint between each of the pendulum rods 3b and the structure 2. In addition, the first pendulum 3 has such a joint 3c between the pendulum rods 3b and the first pendulum mass 3a in each case in order to couple the first pendulum mass 3a in an articulated manner to the two pendulum rods 3b.

The second pendulum 4 is designed as an inverse or standing pendulum. In this embodiment, the second pendulum 4 also includes two pendulum rods 4b which engage below the two lateral ends of the second pendulum mass 4a. The second pendulum 4 is also designed as a transverse pendulum. For this purpose, the second pendulum 4 has a joint 4c in the form of a cardan joint between each of the pendulum rods 4b and the structure 2. In addition, the second pendulum 4 has such a joint 4c in each case between the pendulum rods 4b and the second pendulum mass 4a in order to couple the second pendulum mass 4a in an articulated manner to the two pendulum rods 4b. The first pendulum mass 3a is arranged above the second pendulum mass 4a. Moreover, the first pendulum mass 3a overlaps with the second pendulum mass 4a as seen in vertical direction V. In the example shown here, the first pendulum mass 3a is larger than the second pendulum mass 4a in terms of its spatial dimension in the vertical direction V and its weight. As a result, the entire pendulum arrangement is designed as a particularly stable system.

The structural damper 1 further includes a coupling device 5 disposed between the first pendulum mass 3a and the second pendulum mass 4a and configured to couple the first pendulum mass 3a to the second pendulum mass 4a in an effective direction of the structural damper 1, and to permit relative movement between the first pendulum mass 3a and the second pendulum mass 4a in a direction of movement angled with respect to the effective direction. In the present embodiment, the effective direction of the structural damper 1 is in the horizontal direction H and the direction of motion is in the vertical direction V. The coupling device 5 is arranged in the vertical direction V between the first pendulum mass 3a and the second pendulum mass 4a. For this purpose, the coupling device 5 is connected to the first pendulum mass 3a and the second pendulum mass 4a.

In order to couple the first pendulum mass 3a with the second pendulum mass 4a accordingly and to allow a corresponding relative movement, the coupling device 5 comprises a guide element 5a acting and arranged in the vertical direction V. The guide element 5a is arranged in the vertical direction. Further, the coupling device 5 includes a coupling element 5b. The coupling device 5 is integrated into the second pendulum mass 4a. In particular, the guide element 5a is integrated into the second pendulum mass 4a. In the present example, the guide element 5a is formed as a recess within the second pendulum mass 4a in the form of a vertical guide channel. The coupling element 5b is formed complementary to the guide element 5a. In particular, the coupling element 5b is provided as a vertical extension and is disposed below the first pendulum mass 3a to engage with the guide element 5a within the second pendulum mass 4a. The coupling element 5b can slide along within the guide element 5a, so that the relative movement in the vertical direction V between the first pendulum mass 3a and the second pendulum mass 4a is guided by the coupling device 5. The positive fit between the coupling element 5b and the guide element 5a simultaneously ensures that the first pendulum mass 3a is coupled to the second pendulum mass 4a in the horizontal direction.

Furthermore, the structural damper 1 has a damping device 6. The damping device 6 is arranged between the first pendulum mass 3a and the second pendulum mass 4a, and is configured to damp the relative movement in the vertical direction V between the first pendulum mass 3a and the second pendulum mass 4a. In the present embodiment, the damping device 6 is arranged in the vertical direction V between the first pendulum mass 3a and the second pendulum mass 4a. In particular, the damping device 6 is connected to the first pendulum mass 3a and the second pendulum mass 4a to exert a relative action between the first pendulum mass 3a and the second pendulum mass 4a. In the example shown, the damping device 6 is oriented vertically. Further, the damping device 6 is integrated with both the first pendulum mass 3a and the second pendulum mass 4a. For this purpose, the damping device 6 is arranged in a recess in each of the first pendulum mass 3a and the second pendulum mass 4a.

The damping device 6 includes linear-viscous damping properties. However, it would also be conceivable for the damping device 6 to include non-linear viscous or active damping properties. In the present example, the damping device 6 is designed as a passive hydraulic damper. However, in accordance with the damping characteristics, the damping device 6 may also be formed in a different manner. For example, the damping device 6 can include a semi-active hydraulic damper, an eddy current damper or an active element, in particular an electric motor or a hydraulic actuator.

The structural damper 1 further comprises a stiffness device 7 arranged between the first pendulum mass 3a and the second pendulum mass 4a to stiffen the relative movement in vertical direction V between the first pendulum mass 3a and the second pendulum mass 4a. In the present example, the stiffening device 7 is arranged in the vertical direction V between the first pendulum mass 3a and the second pendulum mass 4a. In particular, the stiffness device 7 is connected to both the first pendulum mass 3a and the second pendulum mass 4a. Further, the stiffness device 7 is vertically oriented. In the embodiment shown, the stiffness device 7 is integrated with the first pendulum mass 3a and the second pendulum mass 4a. In particular, the stiffness device 7 is arranged in a recess in each of the first pendulum mass 3a and the second pendulum mass 4a. The stiffness device 7 is designed as a passive spring. However, the stiffness device 7 can also include a semi-active hydraulic damper or an active element, in particular an electric motor or hydraulic actuator.

With reference to FIGS. 1 and 2, the mode of operation of the structural damper 1 is described below. In FIG. 1, the structural damper 1 is shown in its initial position. The entire pendulum consisting of the first pendulum 3 and the second pendulum 4 is in a central position. FIG. 2, on the other hand, shows the structural damper 1 or the entire pendulum in a displaced position. As soon as vibrations occur in the horizontal direction, the first pendulum mass 3a and the second pendulum mass 4a are displaced horizontally. A horizontal displacement HA of the first pendulum mass 3a and the second pendulum mass 4a occurs. As described above, the first pendulum mass 3a is coupled to the second pendulum mass 4a in the horizontal direction. A relative movement in vertical direction V between the first pendulum mass 3a and the second pendulum mass 4a, however, is allowed. Thus, as the overall pendulum displaces, the first pendulum mass 3a and the second pendulum mass 4a move apart in vertical direction V. In other words, the vertical distance VA between the first pendulum mass 3a and the second pendulum mass 4a increases with the displacement of the pendulum as a whole. Accordingly, the first pendulum mass 3a and the second pendulum mass 4a are moved towards each other again in the vertical direction V as the pendulum swings back to the central position. The vertical distance VA between the first pendulum mass 3a and the second pendulum mass 4a is thus reduced again.

These relative movements in vertical direction V between the first pendulum mass 3a and the second pendulum mass 4a are damped by the damping device 6 and stiffened by the stiffening device 7. The damping device 6 operates in proportion to the relative velocity or relative displacement in the vertical direction V between the first pendulum mass 3a and the second pendulum mass 4a. The horizontal damping force on the first pendulum mass 3a and the second pendulum mass 4 arises during the pendulum motion in the horizontal direction H, since the vertical damping force acts with a horizontal force component on the first pendulum mass 3a and the second pendulum mass 4a. The stiffness device 7 operates in proportion to the relative displacement in the vertical direction V between the first pendulum mass 3a and the second pendulum mass 4a. The stiffness device 7 allows fine tuning of the natural frequency of the coupled first pendulum mass 3a and the second pendulum mass 4a, since the horizontal displacement of the pendulum causes the force of the stiffness device to exert a horizontal component on the first pendulum mass 3a and the second pendulum mass 4a.

The above-described embodiment provides an improved structural damper for protecting structures against vibrations, which requires a small installation space or has a particularly compact and simple design and at the same time operates reliably.

FIGS. 3 and 4 show a structural damper 1 according to a second embodiment of the present invention. FIG. 3 shows the structural damper 1 and the entire pendulum in a central position. In FIG. 4, on the other hand, the entire pendulum is shown in a displaced position. The structural damper 1 of the second embodiment corresponds essentially to the structural damper 1 of the first embodiment. The identical components will not be further discussed below. However, the structural damper 1 of the second embodiment form differs in that the first pendulum mass 3a is arranged below the second pendulum mass 4a. The spatial dimensions of the first pendulum mass 3a and the second pendulum mass 4a are adapted accordingly, so that displacement of the overall pendulum is still possible. In addition, the guide element 5a is integrated into the first pendulum mass 3a and the coupling device 5b is arranged below the second pendulum mass 4a. With the present embodiment, the first pendulum 3 and the second pendulum 4 have the longest possible pendulum length with the smallest possible installation space of the structural damper 1.

The operation of the structural damper 1 corresponds in principle to that of the first embodiment. However, here it is the case that when the pendulum is displaced in the horizontal direction H, the first pendulum mass 3a and the second pendulum mass 4a move in the vertical direction relative to each other. Further, as the pendulum returns to the central position, the first pendulum mass 3a and the second pendulum mass 4a move apart in the vertical direction V. The vertical distance VA between the first pendulum mass 3a and the second pendulum mass 4a behaves accordingly.

FIG. 5 shows a structural damper 1 according to a third embodiment of the present invention. The structural damper 1 of the third embodiment corresponds essentially to the structural damper 1 of the first embodiment. The identical components will not be further discussed below. However, the structural damper 1 of the third embodiment differs in that the coupling device 5 has an end stop 5d. In this example, the guide element 5a has the end stop 5d. The end stop 5d is configured to limit the relative movement in the vertical direction V between the first pendulum mass 3a and the second pendulum mass 4a. For this purpose, the guide element 5a and the coupling element 5b are T-shaped. The end stop 5d is arranged in the vertical direction at the upper end of the guide element 5a in the form of a perforated stop plate, and the coupling element 5b is guided through the corresponding hole in the stop plate. Thus, when the entire pendulum is displaced, with a sufficiently large displacement of the entire pendulum, the coupling member 5b strikes the end stop 5d of the guide member 5a in the vertical direction. In this way, the maximum horizontal displacement of the entire pendulum can be limited.

FIG. 6 shows a structural damper 1 according to a fourth embodiment of the present invention. The structural damper 1 of the fourth embodiment corresponds essentially to the structural damper 1 of the third embodiment. The identical components will not be further discussed below. However, the structural damper 1 of the fourth embodiment form differs in that the coupling device 5 has an active stop device 5e instead of an end stop. In principle, the active stop device 5e is formed in the same way as the end stop 5d. However, the active stop device is additionally designed to limit the maximum possible relative movement in vertical direction V between the first pendulum mass 3a and the second pendulum mass 4a and, at the same time, to change it during the use state of the structural damper 1. To this end, the active stop device 5e comprises a motor that can change the vertical position of the stop plate within the guide element 5a. For example, after each oscillation cycle of the pendulum, the stop plate can be moved down a little further, so that the maximum possible horizontal displacement is increasingly limited and ultimately stopped.

In FIG. 7, a structural damper 1 according to a fifth embodiment of the present invention is illustrated. The structural damper 1 of the fifth embodiment corresponds essentially to the structural damper 1 of the second embodiment. The identical components will not be further discussed below. However, the structural damper 1 of the fifth embodiment differs in that here, too, the coupling device 5 has an end stop 5d which is designed to limit the relative movement in the vertical direction V between the first pendulum mass 3a and the second pendulum mass 4a. In this example, the guide member 5a is formed as a rectilinear guide channel within the first pendulum mass 3a. The coupling element 5b, on the other hand, is formed in a T-shape to be guided within the guide element 5a in a vertical direction V. The end stop 5d is disposed at the vertical lower end of the guide member 5a. Further, the end stop 5d is formed as a continuous stop plate. Thus, when the entire pendulum is displaced, with a sufficiently large displacement of the entire pendulum, the coupling member 5b strikes the end stop 5d of the guide member 5a in the vertical direction. In this way, the maximum horizontal displacement of the entire pendulum can be limited.

FIG. 8 shows a structural damper 1 according to a sixth embodiment of the present invention. The structural damper 1 of the sixth embodiment corresponds essentially to the structural damper 1 of the fifth embodiment. The identical components will not be further discussed below. However, the structural damper 1 of the sixth embodiment form differs in that the coupling device 5 has an active stop device 5e instead of an end stop. The active stop device 5e is formed in principle like the end stop 5d. However, the active stop device 5e is further configured to limit the maximum possible relative movement in the vertical direction V between the first pendulum mass 3a and the second pendulum mass 4a and, at the same time, to change it during the use state of the structural damper 1. For this purpose, the active stop device 5e comprises a motor that can change the vertical position of the stop plate within the guide element 5a. For example, after each oscillation cycle of the pendulum, the stop plate can be moved a little further upwards, so that the maximum possible horizontal displacement is increasingly limited and ultimately stopped.

FIGS. 9 and 10 show a structural damper 1 according to a seventh embodiment of the present invention. FIG. 9 illustrates the entire pendulum in the central rest position. In contrast, FIG. 10 illustrates the entire pendulum in a displaced position. The structural damper 1 of the seventh embodiment is essentially the same as the structural damper 1 of the first embodiment. The identical components will not be further discussed below. However, the structural damper 1 of the seventh embodiment differs in that the second pendulum 4 is designed as a physical pendulum. For this purpose, the second pendulum 4 has a single pendulum rod 4b which is rigidly and centrally mounted below the second pendulum mass 4a.

In addition, the first pendulum mass 3a is coupled in an articulated manner to the second pendulum mass 4a. For this purpose, the coupling device 5 has a joint 5c in the form of a universal joint. In the present example, the joint 5c is arranged between the coupling element 5b and the first pendulum mass 3a. Furthermore, the damping device 6 and the stiffness device 7 each have two joints 6a and 7a to enable the articulated coupling of the first pendulum mass 3a to the second pendulum mass 4a. In this embodiment, the damping device 6 is arranged laterally on the first pendulum mass 3a and the second pendulum mass 4a in the vertical direction V. For this purpose, the first pendulum mass 3a has a lateral extension 3d and the second pendulum mass 4a has a lateral extension 4d. The damping device 6 is arranged in the vertical direction V between the lateral extension 3d of the first pendulum mass 3a and the lateral extension 4d of the second pendulum mass 4a via a joint 6a in each case.

The stiffness device 7 is also arranged laterally in the vertical direction V on the first pendulum mass 3a and the second pendulum mass 4a. For this purpose, the first pendulum mass 3a has a further lateral extension 3d and the second pendulum mass 4a has a further lateral extension 4d. The stiffness device 7 is arranged in the vertical direction V between the lateral extension 3d of the first pendulum mass 3a and the lateral extension 4d of the second pendulum mass 4a via a joint 7a in each case.

The operation of the structural damper 1 corresponds in principle to that of the first embodiment. Here, however, it is the case that when the pendulum is displaced in the horizontal direction H, the first pendulum mass 3a is additionally tilted relative to the second pendulum mass 4a, see FIG. 10. The relative displacements or relative velocities in the vertical direction V between the first pendulum mass 3a and the second pendulum mass 4a in the region of the damping device 6 and the stiffening device 7 are thus not identical. After the horizontal displacement HA of the entire pendulum, the vertical distance VA between the extensions 3d and 4d in the area of the damping device 6 and the stiffness device 7 has increased by different amounts.

Ultimately, an improved structural damper is provided for protecting structures against vibrations, which requires a small installation space or is particularly compact and simple in design and at the same time operates reliably.

### REFERENCE SIGNS

1 Structural damper
2 Structure
3 First pendulum
3a First pendulum mass
3b Pendulum rod
3c Joint
3d Lateral extension
4 Second pendulum
4a Second pendulum mass
4b Pendulum rod
4c Joint
4d Lateral extension
5 Coupling device
5a Guide element
5b Coupling element
5c Joint
5d End stop
5e Active stop device
6 Damping device
6a Joint
7 Stiffness device
7a Joint
H Horizontal direction
HA Horizontal displacement
V Vertical direction
VA Vertical distance

1. A structural damper for protecting structures against vibrations, comprising:
a first pendulum with a first pendulum mass;
a second pendulum with a second pendulum mass;
a coupling device; and
a damping device,
wherein the coupling device is arranged between the first pendulum mass and the second pendulum mass and is configured to couple the first pendulum mass to the second pendulum mass in an effective direction of the structural damper and to allow relative movement between the first pendulum mass and the second pendulum mass in a direction of movement angled to the effective direction,
wherein the damping device is arranged between the first pendulum mass and the second pendulum mass and is designed to damp the relative movement in the direction of movement between the first pendulum mass and the second pendulum mass (4a),
wherein the coupling device comprises a guide element,
characterized in that
the coupling device has an end stop which is formed in such a way that the relative movement in the direction of movement between the first pendulum mass and the second pendulum mass is limited,
wherein the end stop is integrated into the guide element.

2. The structural damper according to claim 1,
characterized in that
the effective direction of the structural damper has a horizontal component or is in the horizontal direction.

3. The structural damper according to claim 1,
characterized in that
the direction of movement has a vertical component or is in the vertical direction.

4. The structural damper according to claim 1,
characterized in that
the first pendulum is a suspended pendulum, a suspended pendulum having a rope suspension, or a pendulum rod suspension.

5. The structural damper according to claim 1,
characterized in that
the second pendulum is an inverted pendulum, in particular a standing pendulum.

6. The structural damper according to claim 1,
characterized in that
the first pendulum mass is arranged below or above the second pendulum mass in the direction of movement.

7. The structural damper according to claim 1,
characterized in that
the coupling device is arranged in the direction of movement between the first pendulum mass and the second pendulum mass.

8. The structural damper according to claim 1,
characterized in that
that the coupling device is integrated into the first pendulum mass and/or the second pendulum mass.

9. The structural damper according to claim 1,
characterized in that
the guide element is acting in and/or being arranged in the direction of movement.

10. (canceled)

11. The structural damper according to claim 1,
characterized in that
the coupling device comprises an active stop device which is designed to limit and to change, optionally during a state of use of the structural damper, a maximum possible relative movement in the direction of movement between the first pendulum mass and the second pendulum mass.

12. The structural damper according to claim 1,
characterized in that
the damping device is arranged in the direction of movement between the first pendulum mass and the second pendulum mass.

13. The structural damper according to claim 1,
characterized in that
the damping device is arranged laterally on the first pendulum mass and/or the second pendulum mass in the direction of movement.

14. The structural damper according to claim 1,
characterized in that
the damping device is integrated into the first pendulum mass and/or the second pendulum mass.

15. The structural damper according to claim 1,
characterized in that
the damping device has linear-viscous, non-linear-viscous or active damping properties.

16. The structural damper according to claim 1,
characterized in that
the damping device comprises a passive hydraulic damper, a semi-active hydraulic damper, an eddy current damper and/or an active element, in particular an electric motor or a hydraulic actuator.

17. The structural damper according to claim 1,
characterized in that
the structural damper comprises a stiffness device arranged between the first pendulum mass and the second pendulum mass to stiffen the relative movement in the direction of movement between the first pendulum mass and the second pendulum mass.

18. The structural damper according to claim 17,
characterized in that
the stiffness device is arranged in the direction of movement between the first pendulum mass and the second pendulum mass.

19. The structural damper according to claim 17,
characterized in that
the stiffness device is arranged laterally on the first pendulum mass and/or the second pendulum mass in the direction of movement.

20. The structural damper according to claim 17,
characterized in that
the stiffness device is integrated into the first pendulum mass and/or the second pendulum mass.

21. The structural damper according to claim 17,
characterized in that
the stiffness device comprises a passive spring, a semi-active hydraulic damper and/or an active element, in particular an electric motor or a hydraulic actuator.

22. The structural damper according to claim 1,
characterized in that
the first pendulum is designed as a transversal pendulum or physical pendulum.

23. The structural damper according to claim 1,
characterized in that
the second pendulum is designed as a transversal pendulum or physical pendulum.

24. The structural damper according to claim 1,
characterized in that
the second pendulum has a pendulum rod.

25. The structural damper according to claim 1,
characterized in that
the first pendulum mass and the second pendulum mass are coupled to each other in an articulated manner.

26. A structure comprising the structural damper according to claim 1, wherein the structure is a wind turbine or a high-rise building.
